(19) United States
(12) Patent Application Publication
(10) Pub. No.: US 2004/0148757 A1
(43) Pub. Date: Aug. 5, 2004

(54) Pin and method for fastening the pin in an undercut hole

(76) Inventor: Gordon Tang, Bellevue, WA (US)

Correspondence Address: Robert M. Storwick, PO Box 386, Mercer Island, WA, 98040, US

(21) Appl. No.: 10/457,598

(22) Filed: Jun. 9, 2003

Related U.S. Application Data
(63) Continuation-in-part of application No. 10/355,679, filed on Jan. 30, 2003.

(51) Int. Cl. B23P 11/00

(52) U.S. Cl. 29/521

(57) ABSTRACT

A pin and method for fastening the pin in an undercut hole. The pin has an internal end for placement within the undercut hole and an opposite external end that extends away from the undercut hole. The internal end is made from a malleable material such as an annealed material. If desired, the external end can be made from a hardened material. The pin is fastened in the undercut hole by placing the internal end of the pin in the undercut hole and impacting the external end of the pin, thereby causing the internal end of the pin to substantially conform to the interior of the undercut hole and fastening the pin in the undercut hole.

### CROSS-REFERENCE TO OTHER PATENT APPLICATIONS

This application is a continuation-in-part of U.S. patent application Ser. No. 10/355,679, filed Jan. 30, 2003.

© Copyright 2003, Robert M. Storwick. All rights reserved.

A portion of the disclosure of this patent document contains material that is subject to copyright protection. The copyright owners have no objection to the facsimile reproduction by anyone of the patent document or the patent disclosure, as it appears in the Patent and Trademark Office patent files or records, but otherwise reserve all copyrights whatsoever.

### TECHNICAL FIELD

The present invention relates to methods and apparatus for cutting or grinding material. More particularly, the present invention relates to methods and apparatus for forming an undercut hole in a piece of material.

### BACKGROUND OF THE INVENTION

From time to time, it is helpful to secure a pin solidly into a piece of material. It is known to force a tapered pin into a hole that has been drilled for that purpose, or to adhere a pin in the hole (by various means known to those skilled in the relevant arts, such as adhesives, welding, soldering, brazing, and so forth.). However, it is desirable to have a method and apparatus to secure an expanding pin into an undercut hole that has been formed in the material.

### SUMMARY OF THE INVENTION

According to one aspect, the invention is a method for fastening an internal end of a pin in an undercut hole, the pin having an opposite external end. The method includes the steps of a) causing the internal end of the pin to be malleable; b) placing the internal end of the pin into the undercut hole; and c) impacting the external end of the pin until the internal end of the pin conforms substantially to the shape of the undercut hole, thereby fastening the pin in the undercut hole.

According to another aspect, the invention is a pin for fastening in an undercut hole. The pin includes an internal end for placement within the undercut hole and an opposite external end, the internal end being malleable.

### BRIEF DESCRIPTION OF THE DRAWINGS

FIG. 1 is a perspective view of an embodiment of a pin that has been installed through the use of the method and apparatus of the present invention.

FIG. 2 is a perspective view of an embodiment of a pin that can be used in accordance with the method and apparatus of the present invention.

FIG. 3 is a perspective view of a first embodiment of an inventive tool that is exemplary of the apparatus of the present invention.

FIG. 4 is a first cross-sectional view illustrating the use of the first embodiment of the tool in producing an undercut hole in accordance with the method and apparatus of the present invention.

FIG. 5 is a second cross-sectional view illustrating the use of the first embodiment of the tool in producing an undercut hole in accordance with the method and apparatus of the present invention.

FIG. 6 is a third cross-sectional view illustrating the use of the first embodiment of the tool in producing an undercut hole in accordance with the method and apparatus of the present invention.

FIG. 7 is a fourth cross-sectional view illustrating the use of the first embodiment of the tool in producing an undercut hole in accordance with the method and apparatus of the present invention.

FIG. 8 is a cross-sectional view illustrating the installation of the pin of FIG. 1 into an undercut hole produced in accordance with the method and apparatus of the present invention.

FIG. 9 is a perspective view of a second embodiment of an inventive tool that is exemplary of the apparatus of the present invention.

FIG. 10 is a top view of the features of the undercut hole made by the second embodiment of the inventive tool.

FIG. 11 is a top view of a third embodiment of an inventive tool that is exemplary of the apparatus of the present invention.

FIG. 12 is a top view of a fourth embodiment of an inventive tool that is exemplary of the apparatus of the present invention.

FIG. 13 is a schematic view of the features of the undercut hole made by the third and fourth embodiments of the inventive tool.

FIG. 14 is a top view of a fifth embodiment of an inventive tool that is exemplary of the apparatus of the present invention.

FIG. 15 is a schematic view of the features of the undercut hole made by the fifth embodiment of the inventive tool.

### DETAILED DESCRIPTION OF THE PREFERRED EMBODIMENT OF THE INVENTION

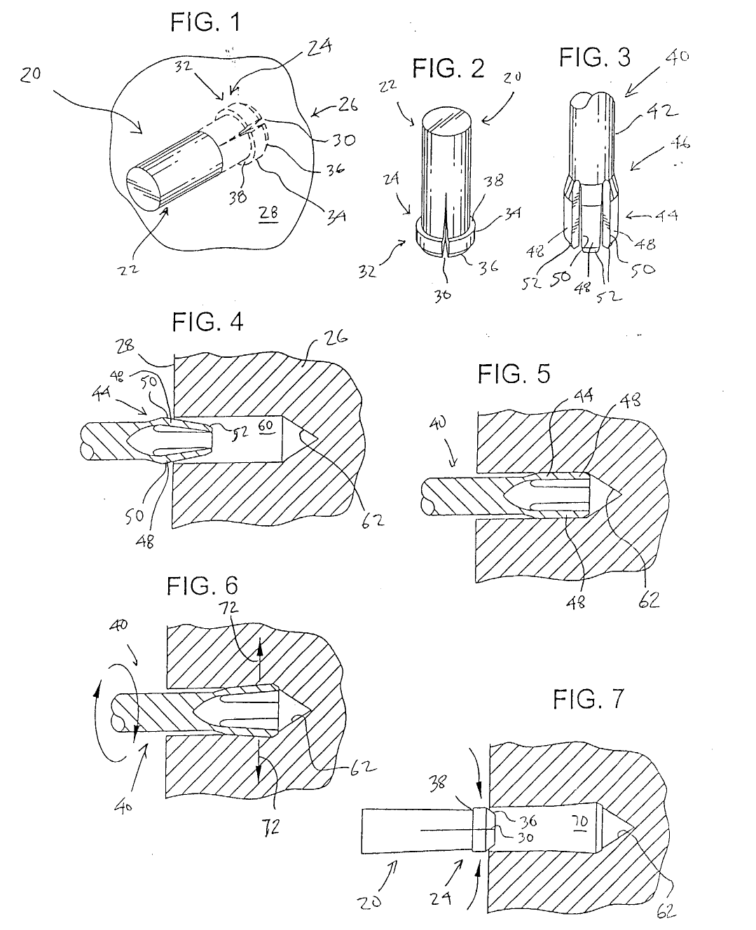

FIG. 1 is a perspective view of an embodiment of a pin that has been installed through the use of the method and apparatus of the present invention, and FIG. 2 is a perspective view of an embodiment of a pin that can be used in accordance with the method and apparatus of the present invention. The pin 20 has an external end 22 and an internal end 24. As shown in FIG. 1, the pin 20 has been installed in a piece of material 26 that has a surface 28. The external end 22 extends outwardly from the surface 28 and the internal end 24 extends inwardly below the surface 28.

The configuration of the pin 20 is used frequently in mechanical applications. These applications include those in which a protrusion from a surface is required, but where the assembly order of the application requires that the protrusion be placed after the application has been at least partially assembled, obviating that the protrusion cannot be made as part of the initial production of the parts of the application. An example of such an application is disclosed in the co-pending United States patent application filed no later than the present application and filed by the inventor of the present application. The external end 22 can be any shape, including an axial shape such as a cylindrical shape, and more specifically, a right cylindrical shape. The internal end 24 is flared outwardly relative to the axial shape of the external end 22. In one particular embodiment, the internal end 24 of the pin 20 can be split, such as by an axial diametric cut 30. Further, the inner perimeter 32 of the internal end 24 can include a circumferential ridge 34 whose innermost edge 36 is tapered and whose outermost edge 38 is an abrupt discontinuity of the outer contour of the pin 20. The innermost edge 36 is tapered to allow the internal end 24 of the pin 20 to be inserted into a hole (not shown in FIG. 1 or 2) that has been formed in the surface 28 of the material 26. The outermost edge 38 is discontinuous to make removal of the pin 20 difficult after it has been fully inserted into the material 26. The disclosed configuration of the pin 20 is particularly useful if the pin 20 is to be inserted into an undercut hole, i.e., a hole whose distal portion is larger in some sense than its proximal portion.

Another embodiment of the pin 20 that is appropriate for insertion and fastening in an undercut hole has a constant cylindrical shape through its entire length between the external end 22 and the internal end 24. Preferably the shape is that of a right circular cylinder. The internal end 24 is made from an annealed material that is malleable and can be formed to the interior shape of the undercut hole. The material at the internal end 24 can be made malleable by annealing the material, as is known by those skilled in the relevant arts.

A further embodiment of the pin 20 has an external end 22 that is hardened, as will be understood by those skilled in the relevant arts. With this embodiment, the internal end 24 of the pin 20 can be made to conform to the undercut hole by impacting the hardened external end 22. The impact can be provided by a hammer or the like, or by other tools known to those skilled in the relevant arts.

FIG. 3 is a perspective view of a first embodiment of an inventive tool that is exemplary of the apparatus of the present invention. The tool 40 includes a shaft 42 and a shaping member 44 formed on a distal end 46. The shaft 42 can be cylindrically shaped, and more particularly, be shaped as a right circular cylinder. The shaping member 44 can be used to create an undercut hole in a material 26. The undercut hole will then be appropriate for use with a pin 20 such as that shown in FIGS. 1 and 2.

The tool 40 (and more particularly, the shaping member 44) can take a large variety of forms in accordance with the invention, as will be understood by those skilled in the relevant arts. As shown in FIG. 3, the shaping member 44 of the tool 40 can be a cutting tool (or shaping member) having a plurality of substantially identical segments 48, each having one or more cutting edges 50. The segments 48 can be created by a plurality of axial diametric cuts; this permits the segments 48 to flex plastically toward the axis of the tool 40, so that the tool 40 will fit into a hole that is smaller than the hole that the tool 40 is capable of forming. Each of the segments 48 has a beveled edge 52 that permits the tool 40 to be inserted into an initial hole that has been formed in the material 26.

The undercut hole with which the tool 40 can be used has a first cylindrical portion adjacent the surface 28 of the material 26 and a second axially symmetric undercut portion displaced from the surface 28 of the material 26. The first cylindrical portion of the hole has a radius R_{H} and the second axially symmetric undercut portion has a maximum radius R_{HMAX} and a minimum radius R_{Hmin}, where R_{H}≦R_{Hmin}<R_{HMAX}.

In general, the shaft 42 has a radius Rs and the shaping member has minimum and maximum external radial extensions of R_{Tmin} and R_{TMAX}. These dimensions satisfy the requirement that R_{Tmin}≦R_{S}≦R_{TMAX}.

FIG. 4-7 are first, second, third and fourth cross-sectional views illustrating the use of the first embodiment of the tool in producing an undercut hole in accordance with the method and apparatus of the present invention. As shown, the initial hole 60 is formed. The initial hole 60 can be formed by a conventional drill bit having a tapered leading cutting portion, creating a conical innermost surface 62. The tool 40 is initiated into the initial hole 60 by use of the beveled edges 52, causing the segments 48 of the tool 40 to flex plastically toward the axis of the tool 40.

After the tool 40 has been inserted into the initial hole 60, the tool 40 can then be pushed forward until it bottoms out in the initial hole 60 (FIG. 5). After the tool 40 bottoms out, it is caused to rotate (FIG. 6), thereby forming an undercut hole 70 (FIG. 7). Then, after removal of the tool 40 from the undercut hole 70, a pin 20 is inserted, the internal end 24 of the pin 20 being compressed so that the axial diametric cuts 30 are closed. This allows the pin 20 to be fully inserted into the hole 60.

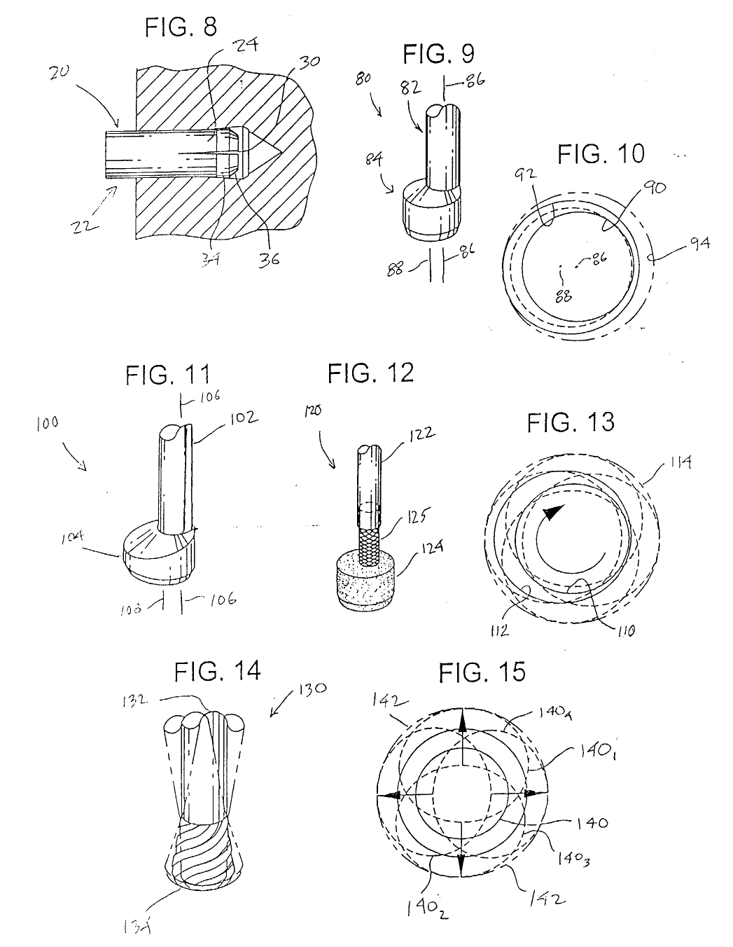

FIG. 8 is a cross-sectional view illustrating the installation of the pin of FIG. 1 into an undercut hole produced in accordance with the method and apparatus of the present invention. As the pin 20 is inserted into the hole 60, the segments 48 expand radially outward (as shown by arrows 72) until, when the pin 20 is fully inserted, they have plastically expanded fully to their original relative positions.

FIG. 9 is a perspective view of a second embodiment of an inventive tool that is exemplary of the apparatus of the present invention, and FIG. 10 is a top view of the features of the undercut hole made by the second embodiment of the inventive tool. In this embodiment, the tool 80 includes a shaft 82 and a cutting portion 84. The shaft 82 has an axis of revolution 86 and the cutting portion 84 has an axis of its center of mass 88. The two axes 86 and 88 are not coincident. As shown in FIG. 10, the circular outline 90 of the shaft 82 is not concentric with the outline 92 of the cutting portion 84. The greatest circumference 94 of the undercut hole 70 includes the outlines of any of the components of the tool 80.

The entire periphery of the cutting portion 84 can have a fixed longitudinal extent, as shown in FIG. 9. However, by varying the density of the material in the cutting portion 84 appropriately, the axial stability of the tool 80 can controlled. At one extreme, the tool 80 can be made so that it will rotate about the axis 86 of the shaft 82 without vibration. Alternately, the tool 80 can be made to vibrate to a great extent. Depending upon the application, it may be advantageous for the tool 80 to have no vibrations, so that the cutting action of the tool 80 can be entirely controlled by positioning the axial position of the shaft 82 within the initial hole 60. On the other hand, it may be advantageous for the tool 80 to have relatively large vibrations, so that the cutting action of the tool 80 is caused by the imbalance of the tool 80.

FIG. 11 is a top view of a third embodiment of an inventive tool that is exemplary of the apparatus of the present invention. In this embodiment, the tool 100 includes a shaft 102 and a cutting portion 104. The shaft 102 has an axis of revolution 106 and the cutting portion 104 has an axis of its center of mass 108. The two axes 106 and 108 are not coincident. As shown in FIG. 13, the circular outline 110 of the shaft 102 is not concentric with the outline 112 of the cutting portion 104. The greatest circumference 114 of the undercut hole 70 includes the outlines of any of the components of the tool 100.

The material that composes the cutting portion 104 can have a fixed density, but a varying longitudinal extent, as shown in FIG. 11. By varying the longitudinal extent of the cutting portion 104 appropriately, the axial stability of the tool 100 can controlled. At one extreme, the tool 100 can be made so that it will rotate about the axis 106 of the shaft 102 without vibration. Alternately, the tool 100 can be made to vibrate to a great extent. Depending upon the application, it may be advantageous for the tool 100 to have no vibrations, so that the cutting action of the tool 100 can be entirely controlled by positioning the axial position of the shaft 102 within the initial hole 60. On the other hand, it may be advantageous for the tool 100 to have relatively large vibrations, so that the cutting action of the tool 100 is caused by the imbalance of the tool 100. As also shown in FIG. 11, a portion of the shaft 102 can extend outwardly beyond the corresponding portion of the tool 100.

FIG. 12 is a top view of a fourth embodiment of an inventive tool that is exemplary of the apparatus of the present invention. In this embodiment, the tool 120 includes a shaft 122, a cutting portion 124 and a flexible cable 125 connecting the shaft 122 to the cutting portion 124. (The cutting portion 124 is shown as a grinding element. It will be understood by those skilled in the relevant arts that any cutting tools disclosed in this specification could equally well be grinding tools, and vice versa. Furthermore, any tools can be any conventional tools known to those skilled in the relevant arts.) Because of the presence of the flexible cable 125, the axis of dynamic rotation of the shaft 122 will not be coincident with the axis of dynamic rotation of the cutting portion 124. Since the cutting portion 124 will be only loosely coupled to the motions of the shaft 122, the cutting portion 124 will wobble within the initial hole 60, allowing the cutting portion 124 to create the undercut hole. Again, as shown in FIG. 13, the circular outline 110 of the shaft 122 is not concentric with the outline 112 of the cutting portion 124. The greatest circumference 114 of the undercut hole 70 includes the outlines of any of the components of the tool 120.

FIG. 13 is a schematic view of the features of the undercut hole made by the third and fourth embodiments of the inventive tool.

FIG. 14 is a top view of a fifth embodiment of an inventive tool that is exemplary of the apparatus of the present invention. In this embodiment, the tool 130 has a shaft 132 and a cutting portion 134. As shown by the phantom lines, once the tool 130 has been inserted into the initial hole 60, the tool 130 can be made to wobble, creating the undercut hole 70.

FIG. 15 is a schematic view of the features of the undercut hole made by the fifth embodiment of the inventive tool. As shown in FIG. 15, the circular outline 140 of the tool 130 can rotate to alternate positions 140₁, 140₂, 140₃ and 140₄. The greatest circumference 142 of the undercut hole 70 includes the outlines of any of the components of the tool 130.

While the foregoing is a detailed description of the preferred embodiment of the invention, there are many alternative embodiments of the invention that would occur to those skilled in the art and which are within the scope of the present invention. For example, the internal end 24 of the pin 20 can have any shape as long as it can be inserted into the undercut hole and as long as it is made from a malleable material. Accordingly, the present invention is to be determined by the following claims.

1. A method for fastening an internal end of a pin in an undercut hole, the pin having an opposite external end and the method comprising the steps of:
a) causing the internal end of the pin to be malleable;
b) placing the internal end of the pin into the undercut hole; and
c) impacting the external end of the pin until the internal end of the pin conforms substantially to the shape of the undercut hole, thereby fastening the pin in the undercut hole.

2. The method of claim 1, wherein step a) includes annealing the internal end of the pin.

3. The method of claim 1, further comprising the step of:
d) causing the external end of the pin to be hardened.

4. A pin for fastening in an undercut hole, the pin comprising an internal end for placement within the undercut hole and an opposite external end, the internal end being malleable.

5. The pin of claim 4, wherein the internal end is annealed.

6. The pin of claim 4, wherein the external end is hardened.
